(19) United States
(12) Patent Application Publication
(10) Pub. No.: US 2019/0224715 A1
(43) Pub. Date: Jul. 25, 2019

(54) METHOD FOR APPLYING A CORROSION-RESISTANT COATING TO A METAL PART, AQUEOUS COATING COMPOSITION, CORROSION-RESISTANT COATING FOR METAL PARTS AND COATED METAL PART

(71) Applicant: NOF METAL COATINGS EUROPE, Creil (FR)

(72) Inventors: Florent COZETTE, Montataire (FR); Sébastien CARBON, Etouy (FR); Didier LABOUCHE, Saint Amano Les Eaux (FR); Carine FEVRIER, Creil (FR)

(73) Assignee: NOF Metal Coatings Europe, Creil (FR)

(21) Appl. No.: 15/758,297

(22) PCT Filed: Sep. 7, 2016
(86) PCT No.: PCT/FR2016/052225

§ 371 Date: Mar. 7, 2018

(30) Foreign Application Priority Data
Sep. 7, 2015 (FR) 1558281

(51) Int. Cl. B05D 7/18; B05D 3/00; B05D 3/12; B05D 3/10; C09D 7/48; C09D 7/40; C09D 5/08

(52) U.S. Cl. CPC B05D 7/18; B05D 3/007; B05D 3/12; B05D 3/108; B05D 2401/20; C09D 7/70; C09D 5/086; B05D 2602/00; B05D 2202/10; C09D 7/48

(57) ABSTRACT

The invention relates to a method for applying a corrosion-resistant coating to a metal part by immersing/withdrawing said part in/from an aqueous paint bath. The invention is characterized in that the aqueous paint bath includes water, a binder and cellulose microfibrils, and in that the coated metal part is subjected to vibrations when removed from the bath.

The invention also relates to an aqueous coating composition including water, a binder, metal particles and CMNFs.

The invention also relates to a corrosion-resistant coating for metal parts that is characterized in that it is obtained by the method according to the invention, the coating layer subsequently being subjected to a curing operation preferably at a temperature of between 70° C. and 350° C.

Lastly, the invention relates to a metal part provided with a corrosion-resistant coating according to the invention.

The present invention relates to a method for applying a corrosion-resistant coating to a metal part by immersing/withdrawing the part in/from an aqueous paint bath, making it possible to obtain a uniform coating, the average deposited thickness of which may be adjusted.

The patent EP 808 883 describes a corrosion-resistant coating composition, of which the main solvent is water, enabling corrosion-resistant coatings having satisfactory properties to be obtained even though the coating does not include hexavalent chromium. This coating may be applied by different methods, in particular by spraying, dipping or dipping-centrifugation.

Dipping application techniques are interesting in the sense that they enable an efficiency close to 100%. Once the part is withdrawn, even if a considerable quantity of paint flows from the part, it falls back into the bath (the material to deposit is recycled).

Furthermore, these techniques generate very little emissions of volatile organic compounds compared, for example, to spraying techniques.

They have the major advantage of being able to treat and to protect hollow bodies, inaccessible by other techniques.

Existing technologies do not however make it possible, in particular for voluminous parts and parts of complex shapes, to deposit in a uniform manner, by dipping applications, the desired film thickness.

The addition to the paint bath of traditional rheology agents such as xanthan gums, traditional cellulosic thickeners, organophilic clays, modified urea additives of the type BYK® 420 do not make it possible to obtain a uniform coating at the desired thickness (from 5 to 100 microns).

It has been discovered, in a surprising manner, that the addition of cellulose microfibrils or nanofibrils (CMNF) to the paint bath and the application of vibrations to the coated part, after withdrawal from the bath, makes it possible to obtain uniform coatings, the average deposited thickness of which may be adjusted. The use of traditional rheology agents does not enable such results to be obtained.

CMNFs are materials derived from renewable resources.

Cellulose is a natural polymer. It is a polysaccharide of empirical formula (C₆H₁₀O₅)ₙ composed of linear chains of β (1,4)-D-glucose. These cellulose molecules are bound together by hydrogen bonds thereby forming microfibrils.

From cellulose fibres, CMNFs may be extracted, by mechanical, mechanical-enzymatic transformation or by chemical process.

CMNFs may be obtained from cellulose fibres by homogenisation, then defibrillation (mechanical treatment): the mechanical treatment consists in peeling the cellulose fibre to create filaments. Different methods exist, for example: refining and high pressure homogenisation, cryocrushing, grinding. The production of cellulose microfibrils by the fibrillation of cellulose fibres requires an intense mechanical treatment.

Depending on the origin of the fibres and the fineness that it is wished to obtain, it is possible to carry out a pre-treatment, before the mechanical treatment. The pre-treatment is essentially chemical or enzymatic. Different pre-treatments may be envisaged: alkaline pre-treatment, oxidation pre-treatment (TEMPO), enzymatic pre-treatment. Cellulose microfibrils or nanofibrils (CMNF) manufactured in this manner are constituted of amorphous and crystalline parts. Their characteristics are the following:
Diameter: from 10 to 100 nm, in particular less than 10 nm
Length: up to 100 μm, in particular approximately of 1000 nm

CMNFs may also be produced by chemical process: this is notably the case of CMNFs derived from edible roots or their waste (examples: beet, carrots, etc.). They may for example be in the form of CMNF “tiles” of a maximum average dimension of at least 10 microns and a minimum average dimension less than 1 micron as described in the patent WO2013128196A1.

The invention relates to a method for applying a corrosion-resistant coating to a metal part by immersing/withdrawing said part in/from an aqueous paint bath, characterized in that the paint bath in aqueous phase includes water, a binder, and CMNFs and in that the coated metal part is subjected to vibrations when removed from the bath.

Paint Bath:

The paint bath includes CMNFs.

These CMNFs may be derived from a mechanical treatment or a mechanical-enzymatic treatment. They then advantageously have a length less than 100 μm, advantageously approximately of 1000 nm. Their diameter is advantageously less than 100 nm.

The CMNFs advantageously have a length ranging from 1 to 2 μm and a diameter varying from 20 to 70 nm.

These CMNFs may also be derived from a chemical extraction. They are then advantageously in the form of CMNF tiles, of a maximum average dimension of at least 10 microns and a minimum average dimension of less than 1 micron as described in the patent WO2013128196A1.

These CMNFs are commercially available.

The aqueous paint bath advantageously includes from 0.2 to 8% by dry weight of CMNF, more advantageously from 0.5 to 4% by dry weight of CMNF, compared to the total weight of the bath.

The bath advantageously includes from 3 to 50% by weight, compared to the total weight of the bath, of binder. The binder is advantageously selected from binders based on silane, binders based on titanate, binders based on zirconate, binders based on silicate, binders based on phenoxy resins in aqueous phase cross-linked for example by a melamine. In one alternative of the invention, the bath advantageously includes from 3 to 35% by weight, more advantageously from 3 to 25% by weight, compared to the total weight of the bath, of binder. The binder is then advantageously selected from binders based on silane, binders based on titanate, binders based on zirconate, and mixtures thereof, in particular two by two. In particular, the binder may be a mixture of silane and titanate.

The silane based binder advantageously includes a silane bearing (1) at least one function that can be hydrolysed into a hydroxyl function selected from a C₁-C₄ alkoxy radical and (2) a functionalised radical.

The silane advantageously bears at least one function that can be hydrolysed into a hydroxyl function selected from a C₁-C₄, preferably C₁-C₂, alkoxy radical. The silane advantageously bears three functions that can be hydrolysed into a hydroxyl function, preferably identical. “Function that can be hydrolysed into a hydroxyl function” means any chemical function capable of reacting with water to be transformed into a hydroxyl function —OH.

The silane further bears a functionalised radical, advantageously a radical including an epoxy (oxirane) function, which favours cross-linking and adhesion to the substrate.

The silanes, in the compositions of the present invention, serve as binder agents. They also make it possible to stabilise the coating bath against a harmful autogenous reaction. The silane seems to bind to and passivate the particulate metal, with the result that the stability of the bath of the coating composition is improved. Moreover, it makes it possible to improve the adhesion of the coating and its corrosion resistance. The silane advantageously represents 3 to 20% by weight of the total weight of the bath.

The silane is advantageously easily dispersed in the aqueous medium and is, preferably, soluble in such a medium. The silane used is advantageously a silane with epoxy function selected from di- or trimethoxysilane with epoxy function and di- or triethoxysilane with epoxy function, and mixtures thereof, in particular such as beta-(3,4-epoxycyclohexyl)ethyl-trimethoxysilane, 4-(trimethoxysilyl)butane-1,2-epoxide, gamma-glycidoxypropyltrimethoxysilane or gamma glycidoxypropyltriethoxysilane. The silane used may also advantageously be tetraethoxysilane, octyltriethoxysilane, phenyltriethoxysilane, methyltriethoxysilane vinyltriethoxysilane, 3-aminopropyltriethoxysilane.

The organic titanate may be selected from the group constituted of organic titanates compatible in organic phase and organic titanates compatible in aqueous phase.

The titanates compatible in organic phase are advantageously C₁-C₈ tetraalkyl titanates which may be represented by the following formula (I):

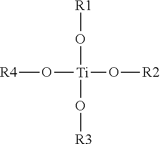

in which R1, R2, R3 and R4 represent independently a C₁-C₈ alkyl radical, optionally substituted. The C₁-C₈ tetraalkyl titanate is advantageously selected from the group constituted of tetraethyltitanate (TET, Ti(OC₂H₅)₄), tetra-n-butyltitanate (T_{b}BT, Ti(OC₄H₉), tetra-isopropoxytitanate and octyleneglycoltitanate (OGT, Tl(O₂C₈H₁₇)₄).

The organic titanates compatible in organic phase may also be organic titanates in chelated form not compatible with water. As examples of organic titanates in chelated form not compatible with water (compatible in organic phase), those sold by Dorf Ketal under the name TYZOR® AA (titanium acetylacetonate), TYZOR® DC (diisopropoxy-bisethylacetoacetato titanate) may notable be cited.

The titanates compatible in aqueous phase are advantageously chelated titanates, which may be represented by the following general formula (II):

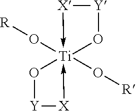

in which R and R′ represent independently of each other a C₁-C₈ alkyl radical, optionally substituted, X and X′ represent independently a functional group including an oxygen or nitrogen atom, and Y and Y′ represent independently a hydrocarbon chain having 1 to 4 carbon atoms. X and X′ advantageously represent an amino or lactate radical.

The organic titanate in chelated form compatible in aqueous phase is advantageously selected from the group constituted of triethanolamine titanates (TYZOR© TE and TEP sold by Dorf Ketal). As example of organic titanates in chelated form compatible in aqueous phase, those sold by Dorf Ketal under the name TYZOR® TA (alkanolamine titanate in chelated form) and TYZOR® LA (chelate of titanium and lactic acid) may also be cited.

The organic zirconate may be selected from the group constituted of zirconates compatible in organic phase and zirconates compatible in aqueous phase.

The organic zirconates compatible in organic phase are advantageously C₁-C₁₀ tetraalkyl zirconates, which may be represented by the following formula (I′):

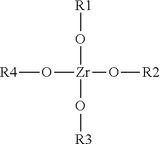

in which R1, R2, R3 and R4 represent independently a C₁-C₁₀ alkyl radical, optionally substituted. The C₁-C₁₀ tetraalkyl zirconate is advantageously selected from the group constituted of tetra-n-propyl zirconate and tetra-n-butyl zirconate.

The organic zirconates compatible in organic phase may also be organic zirconates in chelated form not compatible with water. As example of organic zirconate in chelated form not compatible with water (compatible in organic phase), the one sold by Dorf Ketal under the name TYZOR® ZEC (chelated diethylcitrate zirconate) may notably be cited.

The organic zirconates compatible in aqueous phase are advantageously chelated zirconates which may be represented by the following general formula (II′):

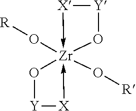

in which R and R′ represent independently of each other a C₁-C₁₀ alkyl radical, optionally substituted, X and X′ represent independently a functional group including an oxygen or nitrogen atom, and Y and Y′ represent independently a hydrocarbon chain having 1 to 4 carbon atoms. X and X′ advantageously represent an amino radical.

The chelated organic zirconate may advantageously be triethanolamine zirconate (TYZOR® TEAZ sold by Dorf Ketal). As example of organic zirconate in chelated form compatible in aqueous phase, the one sold by Dorf Ketal under the name TYZOR® LAZ (chelate of zirconate and lactic acid) may also be cited.

The silicate binders may be alkali metal silicates, organic esters of silicates such as ethyl silicate (U.S. Pat. No. 3,469,071), a colloidal silica sol, organic ammonium silicates (U.S. Pat. No. 3,372,038). The silicates are advantageously silicate(s) of sodium and/or potassium and/or lithium. Aqueous compositions including such silicates are for example described in the patent application WO 03/078683.

The bath advantageously includes 8 to 30% by weight of silicate(s) of sodium and/or potassium and/or lithium, more advantageously from 10 to 25% by weight, compared to the total weight of the bath.

The bath may be an aqueous solution of sodium silicate of following composition by weight:

| | |
|---|---|
| SiO₂ | 20 to 40% by weight |
| Na₂O | 5 to 20% by weight |
| water | q.s. 100% by weight |

This sodium silicate solution may also contain a small proportion of Na₂CO₃ approximately of 0.1% by weight compared to the weight of silicate solution.

The bath may be an aqueous solution of potassium silicate of following composition by weight:

| | |
|---|---|
| SiO₂ | 15 to 35% by weight |
| K₂O | 5 to 35% by weight |
| water | q.s. 100% by weight |

The bath may be an aqueous solution of lithium silicate of following composition by weight:

| | |
|---|---|
| SiO₂ | 15 to 40% by weight |
| Li₂O | 1 to 10% by weight |
| water | q.s. 100% by weight |

The binder may also be a binder based on phenoxy resins dispersed in aqueous phase. Phenoxy resins are polyhydroxyethers having terminal alpha-glycol groups. A grafting onto the aliphatic backbone of these resins leads to anionic dispersions stable in aqueous phase. The terminal OH can notably react with melamines. As examples, the phenoxy resins of the PKHW series sold by the Inchem Corporation may be cited.

The liquid medium of the coating bath is practically always water or a combination of water and organic solvent. Other solvents may optionally be used but, preferably, only in very small quantities. Typically, the bath includes 30 to 85% by weight of water, compared to the total weight of the bath.

The coating bath may also include at least one particulate metal.

The particulate metal may be selected from the group constituted of zinc, aluminium, chromium, manganese, nickel, titanium, alloys and intermetallic mixtures thereof, and mixtures thereof. The particulate metal is advantageously selected from zinc and aluminium, and alloys and mixtures thereof or alloys thereof with manganese, magnesium, tin or Galfan®.

In practice, it turns out that the presence of zinc is highly desirable. The particulate metal is advantageously selected from lamellar zinc and/or lamellar aluminium, and preferably includes lamellar zinc.

When the particulate metal is an alloy or a mixture of zinc and aluminium, the aluminium may optionally be present in very small quantities, for example 1 to 5% by weight of the particulate metal, while nevertheless providing a coating of gloss appearance. Normally, aluminium represents at least 10% by weight of the particulate metal, thus the weight ratio of aluminium to zinc is approximately of 1:9. On the other hand, for economic reasons, aluminium does not represent more than around 50% by weight of the total zinc and aluminium, therefore the weight ratio of aluminium to zinc can reach 1:1. The particulate metal content of the coating composition will not exceed around 40% by weight of the total weight of the composition to maintain the best coating appearance and will normally represent at least 10% by weight to obtain a gloss coating appearance.

The metal may contain in minor quantity one or more solvents, for example dipropylene-glycol and/or white spirit, notably when the metal has been prepared in lamellar form. The particulate metals containing solvent are normally used in the form of pastes, which may be used directly with other ingredients of the composition. However, the particulate metals may also be used in dry form in the coating composition.

The particulate metal present in the composition is advantageously in the form of lamellar powder. The particulate metal advantageously has a particle size less than 100 μm, even more advantageously less than 40 μm.

The bath advantageously includes from 10 to 40% by weight, compared to the total weight of the bath, of particulate metal, advantageously in lamellar form.

In this alternative of the invention, the bath advantageously includes from 3 to 25% by weight, compared to the total weight of the bath, of binder. The binder is advantageously selected from binders based on silane, binders based on titanate, binders based on zirconate, and mixtures thereof, in particular two by two. In particular, the binder may be a silane/titanate binder. The silane, titanate and zirconate are as defined previously.

The bath may also include one or more of the following compounds:
a. 1 to 30% by weight of organic solvent or a mixture of organic solvents, compared to the total weight of the composition

According to an advantageous alternative of the invention, the coating bath further includes 1 to 30% by weight of organic solvent or a mixture of organic solvents, compared to the total weight of the bath. The organic solvents are advantageously selected from the group constituted of glycolic solvents such as glycol ethers, in particular diethylene-glycol, triethylene-glycol and dipropylene-glycol, acetates, propylene-glycol, polypropylene-glycol, nitropropane, alcohols, ketones, propylene glycol methyl ether, trimethyl-2,2,4 pentanediol (1,3) (texanol) isobutyrate, white spirit, xylene and mixtures thereof.

Dipropylene-glycol is particularly advantageous, notably for economic and environmental protection reasons. The quantity of solvents is advantageously less than 25% by weight, even more advantageously less than 16% by weight, compared to the total weight of the bath. When the metal particles are prepared in lamellar form in a solvent, the resulting particulate metal may be in the form of a paste. It may then constitute a part of the organic solvent of the bath.
b. 0.1 to 7% by weight of molybdenum oxide, compared to the total weight of the bath

According to an advantageous alternative of the invention, the coating bath further includes 0.1 to 7% by weight of molybdenum oxide, compared to the total weight of the bath. The presence of molybdenum oxide MoO₃ makes it possible to improve the control of the sacrificial protection offered by the particulate metal. The molybdenum oxide MoO₃ is preferably used in essentially pure orthorhombic crystalline form, having a molybdenum content greater than around 60% by weight. Advantageously, the molybdenum oxide MoO₃ will be used in the form of particles of dimensions between 5 and 200 μm.
c. 0.5 to 10% by weight, compared to the total weight of the bath, of a corrosion-resistance performance enhancer selected from the group constituted of yttrium, zirconium, lanthanum, cerium, praseodymium, in the form of oxides or salts, advantageously yttrium oxide Y₂O₃,

According to an advantageous alternative of the invention, the bath further includes 0.5 to 10% by weight of a corrosion-resistance performance enhancer selected from the group constituted of yttrium, zirconium, lanthanum, cerium, praseodymium, in the form of oxides or salts. Said corrosion-resistance performance enhancer is advantageously yttrium oxide Y₂O₃ or cerium chloride. Said corrosion-resistance performance enhancer may advantageously be associated with the aforesaid molybdenum oxide, in a weight ratio of 0.25<corrosion-resistance performance enhancer: MoO₃<20, advantageously 0.5<corrosion-resistance performance enhancer: MoO₃<16, even more advantageously 0.5<corrosion-resistance performance enhancer: MoO₃<14.
d. 0.2 to 4% by weight, compared to the total weight of the bath, of a corrosion inhibiting pigment such as aluminium triphosphate.

According to an advantageous alternative, the coating bath further includes one or more corrosion inhibiting pigments such as aluminium tri or polyphosphate, phosphates, molybdates, silicates and borates of zinc, strontium, calcium, barium and mixtures thereof, at levels approximately of 0.2 to 4% by weight, compared to the total weight of the coating bath.
e. a silicate of sodium, potassium or lithium, when the binder is not already a silicate.
f. other additives.

The coating bath may also include other additives.

In particular, the coating bath may also include a wetting agent, according to a content advantageously less than 4% by weight, of between 0.1 to 4% by weight, compared to the total weight of the bath.

The bath may also include a pH modifier, generally selected from oxides and hydroxides of alkali metals, advantageously lithium and sodium, oxides and hydroxides of metals belonging to the IIA and IIB groups of the periodic table, such as compounds of strontium, calcium, barium, magnesium and zinc. The pH modifier may also be a carbonate or a nitrate of the aforesaid metals.

The bath according to the invention may also include phosphates, substituents containing phosphorous, such as ferrophosphate (pigment), non-organic salts, in quantities less than 2% by weight compared to the weight of the bath.

The bath is advantageously exempt of chromium VI. The bath may however contain chromium in soluble or insoluble form such as, for example, metal chromium or chromium with a degree of oxidation III.

Vibrations:

According to an essential characteristic of the method according to the invention, the coated metal part is subjected to vibrations when removed from the bath.

The use of vibrations to drain parts immersed in a paint is known. It enables their draining but does not make it possible to adjust the deposited thickness and to obtain a uniform coating film.

In a surprising manner, in association with a bath as described previously, vibrations make it possible not only to drain the part but above all to adjust the deposited thickness and to obtain a uniform coating film. In particular, the combination of CMNF in a bath as described previously and vibrations applied to a part emerging from this bath, make it possible to obtain, after curing, a homogeneous coating at the targeted thickness.

The frequency of the vibrations varies advantageously from 10 to 120 Hz, more advantageously from 25 to 50 Hz.

The acceleration of the vibrations varies advantageously from 10 m/s² to 100 m/s², more advantageously from 15 to 50 m/s².

The amplitude of the vibrations varies advantageously from 0.2 to 15 mm, more advantageously from 1 to 8 mm.

The vibrations may be applied by known devices and may for example be generated by pneumatic, electric or electromagnetic vibrators etc.

The vibrations are advantageously applied parallel to the direction of immersing/withdrawing the part in/from the bath.

Using the method according to the invention, uniform coatings are applied, of which the thickness varies advantageously from 5 μm to 100 μm, more advantageously from 10 μm to 80 μm, even more advantageously from 10 μm to 30 μm.

Coating Composition

The invention also relates to an aqueous coating composition including water, a binder as defined previously, metal particles and CMNFs.

The composition according to the invention is advantageously as described previously.

Corrosion-Resistant Coating and Coated Metal Part

The invention also relates to a corrosion-resistant coating for metal parts, characterized in that it is obtained by the method according to the invention, the coating layer subsequently being subjected to a curing operation preferably carried out at a temperature of between 70° C. and 350° C., preferably at a temperature of between 180° C. and 350° C.

The curing operation may be carried out, for around 10 to 60 minutes, by input of thermal energy, such as by convection or infrared, or for around 30 seconds to 5 minutes by induction.

According to an advantageous embodiment, prior to the curing operation, the coated metal parts are subjected to a drying operation, preferably at a temperature of between 60° C. and 80° C. The operation of drying of the coated metal parts may be carried out by input of thermal energy, such as by convection, infrared or induction, at a temperature of between 30 and 250° C., advantageously between 60° C. and 80° C., by convection or by infrared for 10 to 30 minutes on line or for around 30 seconds to 5 minutes by induction. Before coating, it is advisable in most cases to remove foreign matter from the surface of the substrate, notably by careful cleaning and degreasing.

According to the invention, the corrosion-resistant coating for metal parts is applied to the metal parts to protect, with a uniform thickness advantageously from 5 μm to 100 μm, more advantageously from 10 μm to 80 μm, even more advantageously from 10 μm to 30 μm.

The present invention also extends to the metal part, preferably made of steel or made of steel coated with zinc or with a layer based on zinc deposited by different application modes including mechanical deposition, cast iron and aluminium, providing with a corrosion-resistant coating according to the invention applied by means of the aforesaid compositions.

The metal part may be treated beforehand, for example by a phosphate treatment. Thus, the part may be pre-treated in order to have, for example, a coating of iron phosphate according to a quantity of 0.1 to 1 g/m² or a coating of zinc phosphate according to a quantity of 1.5 to 4 g/m².

The method according to the invention is particularly suited to voluminous metal parts of complex shape, such as for example shock absorber supports, engine mountings, fuel pipes and more generally, mechanically welded parts.

This invention makes it possible, by an immersing/withdrawing technique, to apply a uniform coating, at the desired thickness, to parts which can be voluminous and of complex geometries, and to treat zones that are difficult to access such as hollow bodies.

Technologies of immersing/withdrawing in aqueous phase are economically interesting as they enable an efficiency close to 100%. Furthermore, volatile organic compound emissions are low.

The examples that follow enable the invention to be illustrated.

### EXAMPLE N^{O} 1

In the example that follows, different rheology agents were dispersed in baths of standard composition (CStd):

Bath according to the invention:
A: CStd+0.5% by weight (of dry matter) of Curran THIX 5000 of the Cellucomp Company.

Baths—Comparative Examples:
B: CStd+0.5% by weight (of dry matter) of xanthan gum (Rhodopol 23, supplier: Rhodia)
C: CStd+0.7% by weight (of dry matter) of conventional cellulosic thickener (CELLOSIZE™ QP4400, supplier: Dow Chemical)
D: CStd+1% by weight (of dry matter) of an organophilic clay (Bentone® EW, supplier: Elementis Specialties)
E: CStd+0.75% by weight (of dry matter) of a polyurea (BYK®420, supplier: BYK-Chemie GmbH)

The standard reference composition corresponds to:

| | |
|---|---|
| De-ionized water | 39.06% |
| DPG | 10.29% |
| Synperonic ® 13/6.5 | 3.15% |
| Silquest ® A 187 | 8.66% |
| Zinc* | 32.12% |
| Aluminium** | 5.08% |
| Schwego foam ® | 0.4% |
| Nipar ® S10 | 0.71% |
| Aerosol ® TR70 | 0.53% |

*Zinc in the form of a paste at around 95% in white spirit
**Aluminium in the form of a paste at around 70% in DPG (dipropylene glycol)
Synperonic ® 13/6.5: polyoxyethylene (6.5) isotridecanol surfactant
Silquest ® A187: gamma-glycidoxypropyltrimethoxyysilane
Schwego foam ®: anti-foaming agent
Nipar ® S10: 1-nitropropane
Aerosol ® TR70: anionic surfactant, sodium bistridecyl sulfosuccinate.

To assist the reader, the curing conditions may be defined as below:
Pre-drying: 15 min plateau at 70° C. by convection
Curing T°, duration: 25 min plateau at 310° C. by convection

Table 1 below shows that, in the absence of vibrations applied to a part withdrawn at 1 m/min:
A part withdrawn from bath A, then cured for 25 min at 310° C., does not run, has a high average dry film thickness (62 microns), does not have a uniform appearance.
The parts withdrawn from baths B or C, then cured for 25 min at 310° C., have numerous appearance defects (accumulation of coating at the bottom of the plate, disbonding of the film after curing).
A part withdrawn from bath D, then cured for 25 min at 310° C., has low average thickness and appearance defects.
A part withdrawn from bath E, then cured for 25 min at 310° C. has a low average thickness.

TABLE 1
Comparison, in the absence of vibrations, of the films obtained after curing of
parts withdrawn from CStd baths containing different types of thickening agents

| | Acc. | Speed | Displ. | Frequency | | Thickness (μm) | | | |
|---|---|---|---|---|---|---|---|---|---|
| Bath | m/s² | mm/s | mm | Hz | Flow | Upper | Lower | Average | Observations |
| A | 0 | 0 | 0 | 0 | No | 62 | 64 | 62 | Non-uniform |
| | | | | | | | | | appearance |
| B | 0 | 0 | 0 | 0 | Yes | 60 | 85 | 72 | Delamination at |
| | | | | | | | | | bottom of plate |
| C | 0 | 0 | 0 | 0 | Yes | 35 | 61 | 48 | Delamination at |
| | | | | | Lot | | | | bottom of plate |
| D | 0 | 0 | 0 | 0 | Yes | 14 | 22 | 18 | Bubbling + grains |
| E | 0 | 0 | 0 | 0 | Yes | 12 | 13 | 12 | ok |

Table 2 below shows that, in the presence of vibrations applied to a withdrawn part, parallel to the direction of immersing/withdrawing the part in/from the bath, only the part withdrawn from a CStd bath+0.5% (of active material) of CMNF (bath A), then cured for 25 min at 310° C., has a uniform appearance and an average thickness approximately of 33 microns. The application of vibrations to a part withdrawn from the other baths did not influence the appearance and the deposited thickness.

TABLE 2
Comparison, in the presence of vibrations of around 36 Hz (acceleration of around
18-20 m/s², amplitude of around 1.2-1.3 mm), of films obtained after curing of parts
withdrawn from CStd baths containing different types of thickening agents

| | Acc. | Speed | Displ. | Frequency | | Thickness (μm) | | | |
|---|---|---|---|---|---|---|---|---|---|
| Bath | m/s² | mm/s | mm | Hz | Flow | Upper | Lower | Average | Observations |
| A | 19.6 | 90.4 | 1.219 | 37 | non | 27 | 39 | 33 | Significant effect of |
| | | | | | | | | | vibrations |
| B | 19.8 | 92.3 | 1.231 | 37 | yes | 64 | 83 | 73.5 | Lots of bubbles + flake off |
| C | 19.7 | 92.8 | 1.246 | 37 | yes | 46 | 72 | 59 | Lots of bubbles + flake off |
| D | 18.1 | 92.8 | 1.295 | 36 | yes | 13 | 22 | 17.5 | Lots of bubbles + grains |
| E | 18.2 | 88.4 | 1.241 | 36 | yes | 13 | 14 | 13.5 | Ok |

Table 3 below shows that, in the presence of vibrations applied to a withdrawn part, parallel to the direction of immersing/withdrawing the part in/from the bath, of a higher frequency or amplitude than in table 2, only the part withdrawn from a CStd bath+0.5% (of active material) of CMNF (bath A), then cured for 25 min at 310° C. continues to influence significantly the thickness of the uniform film deposited (33 microns on average for an acceleration of around 18-19 m/s² vs. 25.5 microns for an acceleration of around 29-30 m/5²).

TABLE 3
Comparison, in the presence of vibrations of around 43 Hz (acceleration of around
29-30 m/s², amplitude of around 1.3-1.5 mm), of films obtained after curing of parts withdrawn
from CStd baths containing different types of thickening agents

| Thickener | Acc. | Speed | Displ. | Frequency | | Thickness (μm) | | | |
|---|---|---|---|---|---|---|---|---|---|
| family | m/s² | mm/s | mm | Hz | Flow | Upper | Lower | Average | Observations |
| A | 29.4 | 116.3 | 1.368 | 43 | no | 19 | 32 | 25.5 | Significant effect of |
| | | | | | | | | | vibrations |
| | | | | | | | | | Large difference |
| | | | | | | | | | lower/upper |
| B | 29.3 | 117.3 | 1.329 | 44 | yes | 63 | 78 | 70.5 | Lots of bubbles + flake off |
| C | 29.3 | 123 | 1.48 | 42 | yes | 46 | 100 | 73 | Lots of bubbles + flake off |
| D | 30.8 | 119 | 1.34 | 44 | yes | 14 | 18 | 16 | Lots of bubbles + grains |
| E | 30.1 | 113.7 | 1.289 | 44 | yes | 11 | 13 | 12 | Ok |

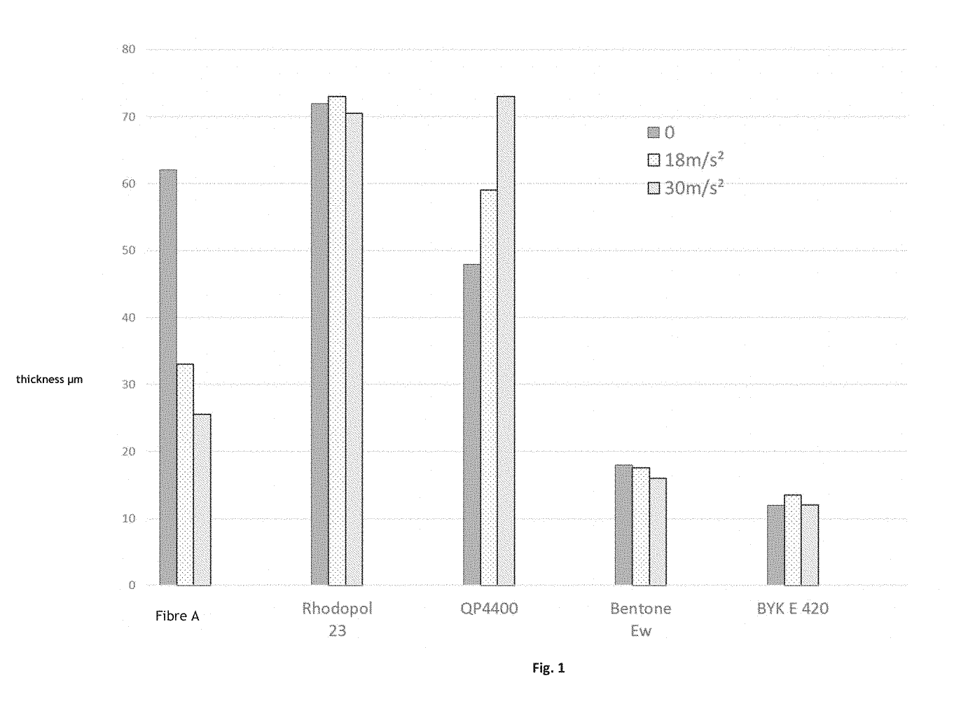

FIG. 1 shows that the vibration (measurable notably via its frequency or its acceleration or instead its amplitude) imposed on the part emerging from the bath A makes it possible to adjust the thickness of the uniformly deposited coating.

FIG. 1: Evolution of the thickness deposited as a function of the acceleration (parallel vibration) as a function of the nature of the rheological agent of the CStd bath (from left to right: Fibre A=NMFC, Rhodopol® 23=xanthan gum, QP4400®=conventional cellulosic thickener, Bentone® EW=organophilic clay, BYK®E 420=thickener of the BYK company of polyurea type).

Grey: acceleration 0 m/s²; dots: acceleration 18 m/s²; dashes: acceleration 30 m/s².

### EXAMPLE N^{O} 2

In the example that follows, two different concentrations of CMNF (of dry matter) were dispersed in the CStd bath:
CStd+0.3% by weight (of dry material) of CMNF (Exilva® of the Borregaard Company
CStd+0.5% by weight (of dry material) of CMNF (Exilva® of the Borregaard Company)

3 parts were immersed then withdrawn in/from each bath at a speed of 1 m/min. 3 vibrations, parallel to the direction of immersing/withdrawing the part in/from the bath, of different acceleration, were imposed on each part before curing:
Vibration of 20 m/5²
Vibration of 47 m/5²
Vibration of 85 m/5²

Table 4 clearly shows that, after curing, the combination of the concentration of CMNF, in the bath, and the type of vibration imposed on the withdrawn part, makes it possible to adjust the thickness of the deposited coating.

TABLE 4
Influence of the concentration of CMNF
and vibration on the deposited thickness

| | Average thickness (microns) | |
|---|---|---|
| Acceleration m/s² | 0.3% CMNF | 0.5% CMNF |
| 20 | 31 | 57 |
| 47 | 22 | 31 |
| 85 | 11 | 16 |

### EXAMPLE N^{O} 3

In the example that follows, other bath compositions were tested:
Silicate: aqueous composition (77% by weight of water, compared to the total weight), sodium silicate binder (23% by weight, compared to the total weight). No metal particles.
Phenoxy: aqueous composition (69% by weight of water, compared to the total weight), phenoxy binder, melamine cross-linked (25% by weight, compared to the total weight), talc (6% by weight compared to the total weight). No metal particles.
Silane/titanate: aqueous composition (69% by weight of water, compared to the total weight), 15% of organic solvents compared to the total weight, silane-titanate binder (15% by weight, compared to the total weight, 50:50 silane/titanium weight ratio), MoO₃ (1% by weight, compared to the total weight). No metal particles.
Silane: aqueous composition (45% by weight of water, compared to the total weight), silane binder (7% by weight, compared to the total weight, organic solvents (18% by weight compared to the total weight), metal particles including zinc (30% by weight, compared to the total weight)

To these baths were added CMNFs (Exilva® sold by Borregaard) at the concentrations expressed in the following table (% by dry weight, compared to the total dry matter).

The parts were immersed in these baths at an immersion speed of 1 m/min. Vibrations were applied, parallel to the direction of immersing/withdrawing the part in/from the bath.

The results are given in the following table:

TABLE 5

| | Lamellar | % | Acceleration (m/s²) | | | |
|---|---|---|---|---|---|---|
| Type of binder | Zn? | CMNF | 0 | 15 | 30 | 70 |
| Silane + Titanate | No | 1 | 47 μm | 62 μm | 29 μm | 11 μm |
| Silicate | No | 0.6 | 92 μm | 63 μm | 47 μm | 20 μm |
| Phenoxy melamine | No | 0.6 | 104 μm | 98 μm | 53 μm | 27 μm |
| Silane | Yes | 0.50% | >100 μm | 33 μm | 25 μm | 20 μm |

These results demonstrate that the same effect is obtained with other binder technologies.

1.-17. (canceled)

18. A method for applying a corrosion-resistant coating to a metal part by immersing/withdrawing said part in/from an aqueous paint bath, wherein the aqueous paint bath includes water, a binder and cellulose microfibrils or nanofibrils (CMNFs), and the coated metal part is subjected to vibrations when removed from the bath.

19. The method according to claim 18, wherein the CMNFs have a length less than 100 μm and a diameter less than 100 nm.

20. The method according to claim 19, wherein the CMNFs have a length ranging from 1 to 2 μm and a diameter varying from 20 to 70 nm.

21. The method according to claim 18, wherein the CMNFs are in a tile-form of a maximum average dimension of at least 10 microns and a minimum average dimension less than 1 micron.

22. The method according to claim 18, wherein the aqueous paint bath includes 0.2 to 8% by weight, compared to the total weight of the bath, of cellulose microfibrils.

23. The method according to claim 18, wherein the bath includes 3 to 50% by weight, compared to the total weight of the bath, of binder.

24. The method according to claim 18, wherein the binder is selected from binders based on silane, binders based on titanate, binders based on zirconate, binders based on silicate, binders based on cross-linked phenoxy resins in aqueous phase.

25. The method according to claim 18, wherein the bath includes from 30 to 85% by weight, compared to the total weight of the bath, of water.

26. The method according to claim 18, wherein the bath includes from 10 to 40% by weight, compared to the total weight of the bath, of particulate metal.

27. The method according to claim 26, wherein the particulate metal is in lamellar form.

28. The method according to claim 26, wherein the particulate metal is selected from zinc, aluminium, chromium, manganese, nickel, titanium, alloys and intermetallic mixtures thereof, and mixtures thereof.

29. The method according to claim 18, wherein the bath also includes one or more of the following compounds:
a. 1 to 30% by weight of organic solvent or a mixture of organic solvents, compared to the total weight of the bath,
b. 0.1 to 7% by weight of molybdenum oxide, compared to the total weight of the bath,
c. 0.5 to 10% by weight, compared to the total weight of the bath, of a corrosion-resistance performance enhancer selected from the group constituted of yttrium, zirconium, lanthanum, cerium, praseodymium, in the form of oxides or salts,
d. 0.2 to 4% by weight, compared to the total weight of the composition, of a corrosion inhibiting pigment such as aluminium triphosphate,
e. A silicate of sodium, potassium or lithium.

30. The method according to claim 29, wherein the corrosion-resistance performance enhancer is Y₂O₃.

31. The method according to claim 18, wherein acceleration of the vibrations varies from 10 m/s² to 100 m/s².

32. An aqueous coating composition including water, a binder, metal particles and CMNFs.

33. A corrosion-resistant coating for metal parts, wherein it is obtained by the method according to claim 18, the coating layer subsequently being subjected to a curing operation.

34. The corrosion-resistant coating for metal parts according to claim 33, wherein the curing operation is carried out at a temperature of between 70° C. and 350° C.

35. The corrosion-resistant coating for metal parts according to claim 33, wherein prior to the curing operation, the coated metal parts are subjected to a drying operation.

36. The corrosion-resistant coating for metal parts according to claim 35, wherein the drying operation is carried out at a temperature of between 60° C. and 80° C.

37. The corrosion-resistant coating for metal parts according to claim 33, wherein it is applied to the metal parts to protect, with a uniform thickness of between 5 and 100 μm.

38. The corrosion-resistant coating for metal parts according to claim 33, wherein it is applied to the metal parts to protect, with a uniform thickness of between 10 and 30 μm.

39. A metal part provided with a corrosion-resistant coating according to claim 33.
